(19) United States
(12) Patent Application Publication
(10) Pub. No.: US 2007/0278989 A1
(43) Pub. Date: Dec. 6, 2007

(54) Power supply with solar charged battery

(76) Inventor: Jay Leboff, Bedford, NY (US)

Correspondence Address: OSTROLENK FABER GERB & SOFFEN, 1180 AVENUE OF THE AMERICAS, NEW YORK, NY, 100368403, US

(21) Appl. No.: 11/804,183

(22) Filed: May 17, 2007

Related U.S. Application Data
(60) Provisional application No. 60/801,195, filed on May 17, 2006.

(51) Int. Cl. H02J 7/00

(52) U.S. Cl. 320/101

(57) ABSTRACT

An apparatus for charging a battery and a battery comprising an electrical storage battery, an exterior housing around the battery; the housing having a plurality of walls, an array of photovoltaic cells on one of the walls of the housing; an electrical connection from the cells to charge the battery.

### CROSS-REFERENCE TO RELATED APPLICATIONS

The present application is based on and claims the benefit and priority to U.S. Provisional Patent Application Ser. No. 60/801,195, filed on May 17, 2006 and entitled “POWER SUPPLY WITH SOLAR CHARGED BATTERY,” the entire contents of which are hereby incorporated by reference.

### SUMMARY OF THE INVENTION

The present invention relates to a solar panel charger for an electrical storage battery wherein the battery is in turn connectable to electrically powered, periodically electrically chargeable objects, such as cell phones, personal digital assistants, and portable personal computers, as a few examples. This apparatus is intended to provide a power supply for devices when there is no conventional electrical power, such as during a power outage, or when there is no conventional supply of electricity available. This is a renewable energy device for locations where there is an interruption in conventional electric supply or none at all.

A first embodiments of the apparatus is a fully self contained power unit comprising an external housing having at least one wall comprised of a plurality of conventional photovoltaic cells which are arrayed on the wall, preferably next to each other.

When the array of photovoltaic cells is exposed to sunlight or a source of infrared radiation, they generate electricity. The photovoltaic cells in the array are conventionally, electrically connected to each other and, through leads, the array is connected to charge an electrical energy storage battery, for example, a battery capable of supplying twelve volts at five watts of electricity. Preferably, the battery is a maintenance free battery. Preferably it is a lithium-ion battery.

In the first embodiment, the housing, of which the photovoltaic cells define one wall, is preferably enclosed to protect the battery and to provide support for the wall of photovoltaic cells.

In a preferred form of the first embodiment, the enclosed housing has a triangular, and particularly a right triangular shape, and the wall with the photovoltaic cells is at the hypotenuse. It is contemplated that the housing would be supported and oriented, e.g., by itself being installed on or hung on a wall or placed on a roof or on a surface, so that the photovoltaic cell wall is tilted upwardly to receive sunlight. With a triangular shape housing, one wall is a support for the housing and is either the horizontal wall on a support surface or the vertical wall supported on a wall or support. The external housing may be placed on the ground or may be mounted on a wall above the ground, for example, to be above a snowfall, an obstacle to direct sunlight shining on the array or any other possible interference with the solar array. The angular incline of the triangular shape enables the photovoltaic cell wall to be directed to face south or slightly east or west of south, depending upon the direction in which a user at the installation for the housing believes the cells will have maximum exposure to sunlight. This embodiment is adapted to being mounted outdoors exposed to elements in the environment including weather and climate.

On a wall of the housing, particularly a vertical or supported wall of the triangle, there is mounted an electrical circuit to control the solar charging circuit and also a multi-voltage transformer capable of adjusting the output voltage from the battery to a required level for a particular apparatus being electrically powered by the battery. The transformer may have a plug receptacle or socket capable of replaceably receiving various types and sizes of plugs or a respective wire connected to each such plug, which provide connections to various typically rechargeable electrical apparatus, for example, a cell phone, personal digital assistant, e-mail message unit and laptop computer. As needed for a particular apparatus being charged, the particular plug in the receptacle at the transformer, which may be referred to as a tip, or the wire to such a plug is selected for that particular apparatus to be charged to receive sunlight.

Because the photovoltaic cells charge the battery, when there is no sunlight to charge the cells, the battery holds a charge sufficient to charge the apparatus.

The wall of the housing on which the photovoltaic cells are arrayed is of an appropriate size for providing sufficient charge to the battery. For example, that wall may be 14 inches in height. The entire housing and therefore the wall may be 12 inches in width.

In a modification of the above, a cable from the battery in the housing is connected to an indoor charging station in a building. The cable can be run into the building through a window opening or a penetration in the wall leading to the interior of the building. The plugs or tips would then be positioned on the charging station.

The indoor charging station is to be mounted inside the building on a wall or placed on a shelf or counter. The changing station may have an array of indicator lights or an LCD display. For example, a green light may indicate that the battery is fully charged, a yellow light may indicate that the battery is charging and not fully charged and a red light may indicate that there is some malfunction or problem that should be addressed, to give the operator a chance to correct the problem before the battery is dead and then may be dead or unavailable. There may also be an emergency light that is maintained at full charge by the solar cell and battery circuit. In addition, a flashlight or other appliances may be supported on the charging station and powered by it.

The charging station will contain cables to each of which there would be a plug-in tip adapted to receive a selected plug corresponding to the plug normally on the power cord to each of the individual electrically chargeable devices. The charging station may also house a conventional cigar lighter receptacle for receiving a conventional 12 volt car charger for in turn charging various devices.

It is known in the prior art to provide photovoltaic cells for charging batteries. These are often used for powering illuminated street lamps and emergency telephones on roads. The differences in the first embodiment include, but are not limited to, an enclosed housing, which may be triangular in shape, in which a battery is fully enclosed to protect it, and the means to power various electrical apparatus by the use of different tips for receiving the plugs, and indicators of various conditions of the apparatus.

There are alternate power supply unit designs that use the same principles. In a second embodiment, the power supply unit includes a base unit, which houses the battery, e.g., a 12-volt battery, to be charged and has provision for holding and making accessible the tips which are connected to the battery and which can in turn be connected to respective chargeable devices to be charged by the power unit. An array of photovoltaic cells is on a panel that is attached to the base of the power unit. The panel supporting the photovoltaic cells may be articulately attached to the base to be pivoted between the downturned, e.g., storage, and upraised, e.g., operational, conditions. The cells are on the exterior of the panel. The power unit may be placed inside a building or structure and at a window through which sunlight may shine on the cells to activate the photovoltaic cells to charge the battery. The panel could be raised to an upright condition or it might be angled as needed for optimizing receipt of sunlight shining on the cells.

The indoors power unit may be connected through a transformer with domestic house current which would also charge the battery, in a low or no sunlight condition.

In an alternative design, the photovoltaic cell holding panel may be lifted free of the base unit and placed near a window, for user convenience and if the user does not wish to be in the sunlight or to look into the sunlight when working with the base unit. A power cable between the photovoltaic cell array and the base unit brings power to the battery.

As a further alternative only connects the power unit to domestic house current without supply electricity from any photovoltaic cells.

### BRIEF DESCRIPTION OF THE DRAWINGS

Particulars of embodiments of the invention are shown in the attached drawings in which:

FIG. 1 is a side view of a power supply unit;

FIG. 2 shows a charging station connectable with the unit of FIG. 1;

FIG. 3 shows a perspective view of second embodiment;

FIG. 4 shows a front view thereof; and

FIG. 5 shows a modification thereof.

### DESCRIPTION OF PREFERRED EMBODIMENTS

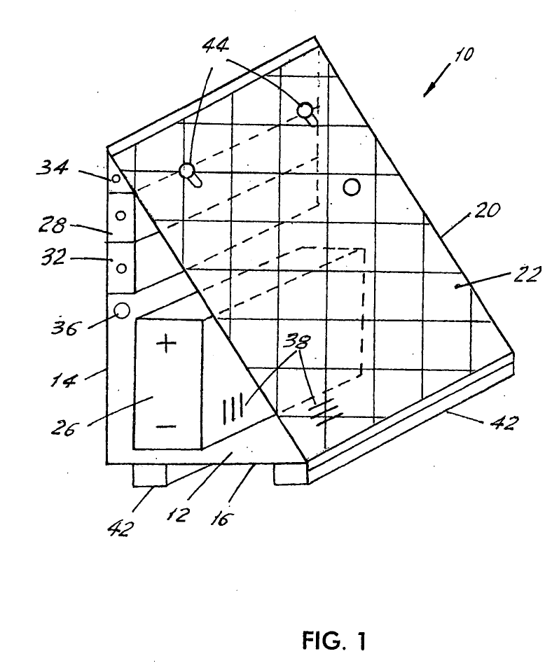

Referring to FIG. 1, the power supply unit 10 includes a fully enclosed housing 12, which as illustrated is triangular in cross-sectional shape, with a rear wall 14, a bottom wall 16 and a front wall 20. The front wall 20 supports and is comprised of a photovoltaic cell panel 22 comprised of a plurality of photovoltaic cells, together supplying 12 volts at 5 watts, for example. For illustrative purposes, and not limiting, the photovoltaic panel is approximately 12 inches in width and 14 inches in height. As illustrated, it is the hypotenuse of a right triangle shaped housing. Depending upon the location where the charger 10 is to be used and access there to sunlight, the charger 10 is preferably supported so that the upwardly tilted side 20 faces toward sunlight, so that in the Northeastern United States, it preferably faces mostly south.

The photovoltaic cells on the front panel 22 are electrically connected to a storage battery 26 which is disposed inside the enclosed housing. Sunlight activates the photovoltaic cells to generate electricity which is transferred by internal connections to the storage battery and charges the battery.

Other elements disposed inside the housing 12 include a multi-voltage transformer 28 connected with the battery for adjusting the voltage levels to a particular device that is to be charged from the storage battery. Typical devices which are to be charged are charged at various voltages and the adjustable transformer permits selection of the correct voltage. There is a control console for the electronic panel and the electronics. There may be an indicator light 34 from the photovoltaic panel indicating that it is supplying electrical charge, for example.

The charger 10 is typically disposed on the exterior of a structure, such as a house or building, where a device to be charged from the battery is located for charging or on the ground away from the building. Therefore, there is a cable connection 36 from the charger into the structure. The fully enclosed housing might have ventilation openings 38 on its walls.

The charger can be mounted in various locations. It may be provided with legs or supports 42 beneath it that would support it off the ground. Alternatively, the rear wall may have conventional mounting openings 44 by which the charger may be hung on a wall or surface above the ground and, more applicable perhaps, above a normal build up of snow, dirt or rocks, etc. Other mounting arrangement may be apparent.

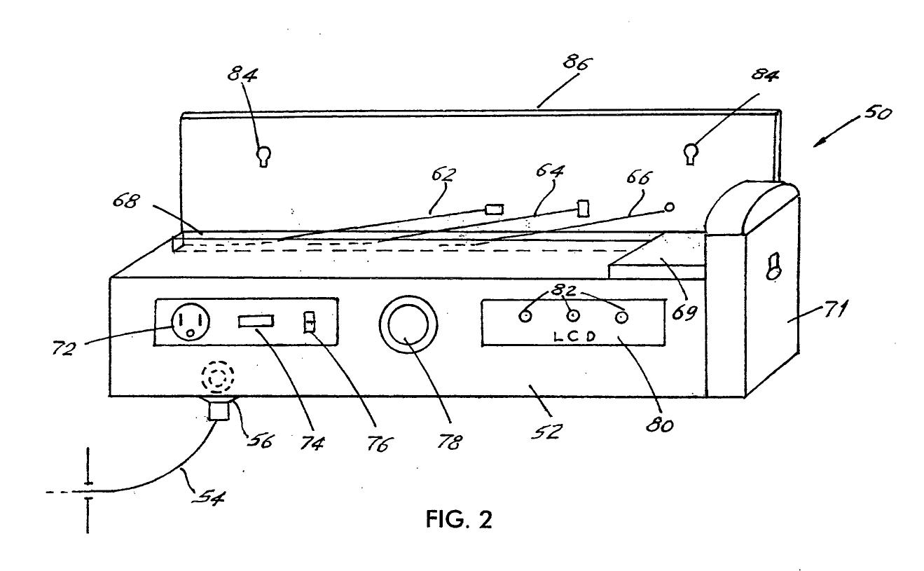

FIG. 2 illustrates a preferably indoor use charging station 50 operable for charging any of various types of rechargeable devices including PDAs, mobile telephones, and any other device which uses a low voltage, rechargeable battery, such as a lithium ion battery. The indoor charging station is to the extent possible as universally useful as possible. It includes a housing 52. There is a connection between the cable 54 from the cable connection 36 in the charger to an electrical input 56 to the charging station.

Internally within the charging station, there are various connecting cables connectable to various types of chargeable units. Representative cables 62, 64, 66 are shown. Each cable has or can receive a respective tip with a plug adapted to a socket in a particular type of chargeable device like a PDA, telephone, etc. The housing 52 includes a recessed tray 68 in which the various tipped cables may be stored. In addition, there may be adaptable tips connectable to other cables and they can be stored in the container 69.

For convenience, a rechargeable flashlight 71 may be permanently installed on the charging station to be available when needed.

In addition to the PDA connection tips, alternatively, there may be an inverter in the housing 52 for providing standard 110 volt AC current to the plug socket 72, perhaps with a control switch 74 therefor. A USB connection 76 may also be provided. There may be another connection at 78 for a 12 volt receptacle, e.g., for a cigar lighter, for chargers that operate from an electrical supply of an automobile.

The unit may include a system status display 80 with several LEDs 82, which when illuminated provide various status indicators as to the status of the charging station and also of the charger 10.

The charging station would be placed on a shelf or counter or mounted on a wall at wall mounts on the rear wall 86 of the housing 52. Connection among the various receptacles and plugs and the power cable 54 are conventional.

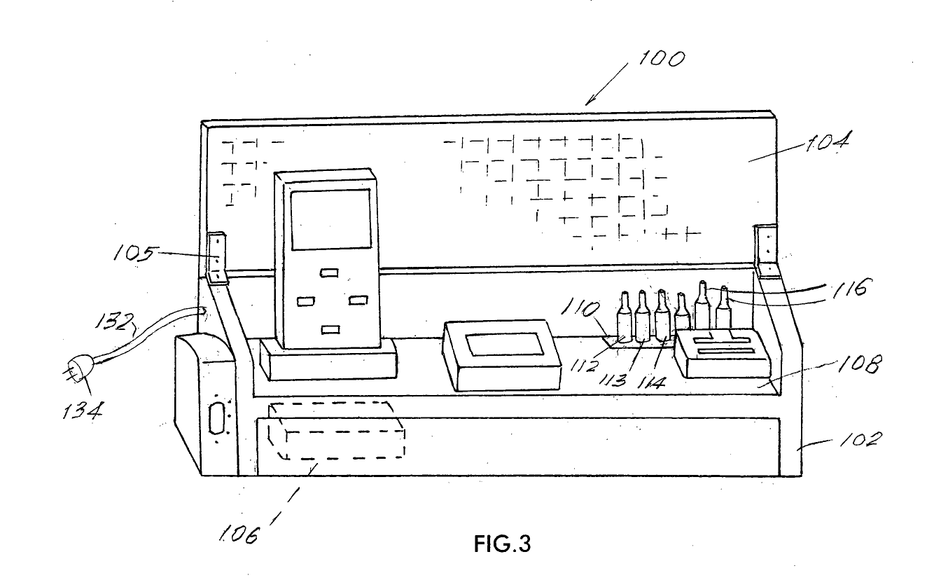

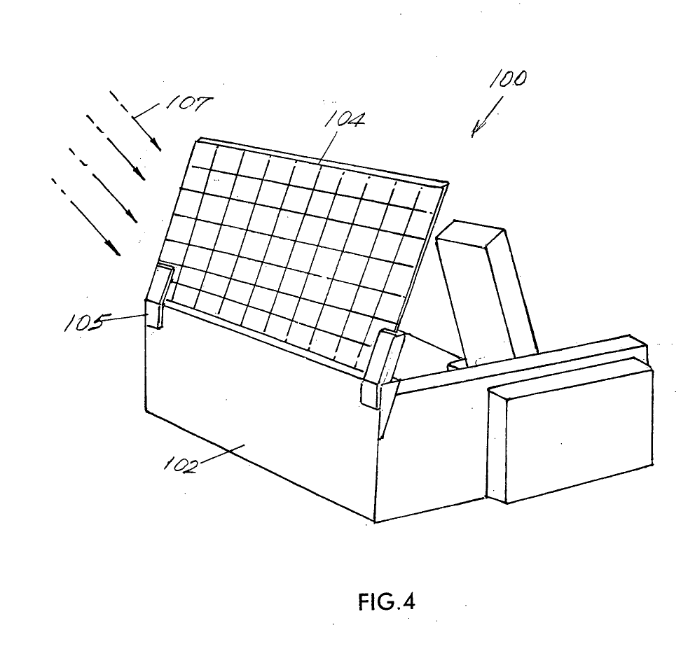

FIGS. 3 and 4 illustrate a second embodiment of a power supply unit 100 comprised of a base unit 102 and a photovoltaic cell panel 104. The photovoltaic cell panel may be rigidly connected to the base unit 102. Alternatively, they may be hinged together at 105 or otherwise articulately connected to enable the cell panel 104 to be pivoted down over the top of the base unit 102 to cover the tips and small chargeable devices that are then on the base unit and to make the power supply unit more compact for storage and transportation. The photovoltaic cell panel 104 may be pivoted straight upright, as illustrated in FIG. 3, or may be inclined slightly, as in FIG. 4, so that the panel may be adjusted to be perpendicular to sunlight 107, to the extent possible. Articulated connections and supports which are adjustable in this manner are readily available.

The base unit 102 may be similar to the indoor charging station 50 in FIG. 2. Without repetition here, it may include all of the elements that are disclosed on the base unit 50. The base unit completely encloses a chargeable 12 volt battery 106 which is connected to the photovoltaic cells in panel 104 in a conventional manner. On the top surface 108 of the base unit 102, there is an area 110 for tip storage supporting several different conventional tips 112, 114, etc. Each tip is selected for being attachable to a respective plug socket on a chargeable device that is typically portable and that should be periodically charged by the user, including various chargeable devices as described above. The tips differ so that each one may be connectable to a respective receptacle or socket for that tip in a respective chargeable device. Each tip is on a respective power cord inside the base unit that is connected to the battery 106. In addition, alternate tips 116 not connected to power cords may be provided in the storage tray and may be substituted on cords for the tips then attached. As in the other embodiment, the tips and their power cords are attached to the battery, sometimes through an appropriate transformer that adjusts the voltage and power level to the tip and the chargeable device.

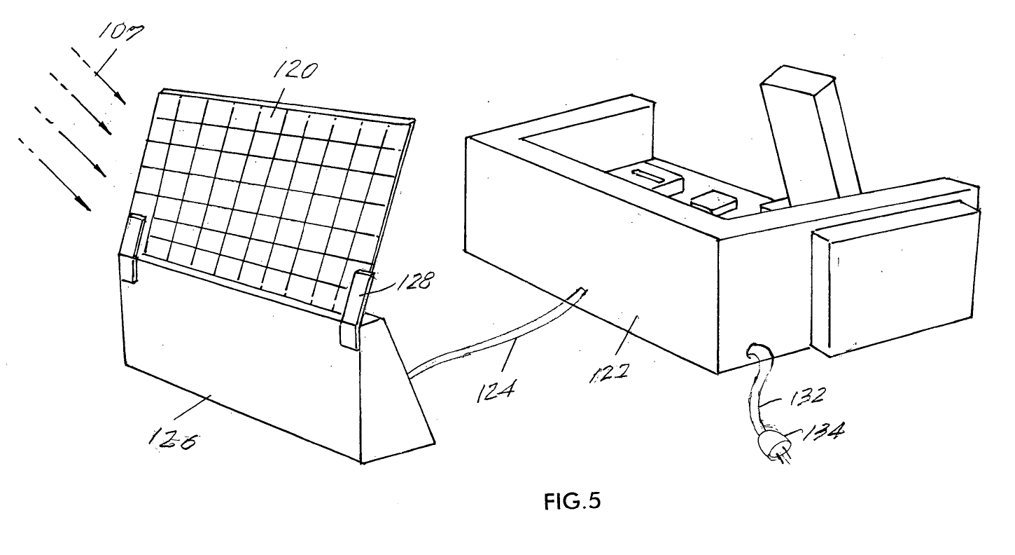

In the alternate embodiment of FIG. 5, the photovoltaic cell array panel 120 is separate from the base unit 122 of the power unit 120. A cable 124 connects them. The panel 120 is supported on a base 126 so it can be free standing. The panel 120 and base 126 are hinged at 128. The cell array panel is sufficiently large or has shaped base able to support the cell array. The storage areas for tips or other apparatus, etc. and for the battery at the base unit 122 may be the same as for the base unit 102.

Especially as the photovoltaic cell arrays 104 and 120 are intended for receiving sunlight through a window, their cell array must be large enough to provide sufficient electrical energy to charge the battery. This is a matter of choice and design.

Especially when a power unit is used in a building, there is access to a standard power supply. For both of the units 100 and 122, the unit may be connected by a cable 132 to a plug 134 for installation in a standard power socket.

A transformer and rectifier between the cable 132 and the 12 volt battery in the housing charges the battery even when there is no sunlight.

Yet another embodiment would comprise the base unit 122 of FIG. 5, disconnected from any photovoltaic electrical energy supply and powered by the power cord 132.

Because chargeable devices are charged not directly from the photovoltaic cells but rather from an intermediate storage battery, so long as there is sufficient voltage generated in the cells by sunlight in order to charge the battery, the chargeable devices can be charged from the battery while the battery is being charged or when the battery is not being charged, that is, when the photovoltaic cells are not exposed to sunlight.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An apparatus for charging a battery and a battery comprising:
an electrical storage battery;
an exterior housing around the battery; the housing having a plurality of walls;
an array of photovoltaic cells on one of the walls of the housing; an electrical connection from the cells to charge the battery.

2. The apparatus of claim 1, wherein the electrical connection comprises a connection cable at one of the walls from the battery for connecting to a charging station for a selected electrical apparatus for charging the apparatus.

3. The apparatus of claim 2, wherein the cable is connected to the charging station through a window or penetration in a building wall.

4. The apparatus of claim 1, wherein the electrical connection is adaptable to receive various connections from different electrical apparatus.

5. The apparatus of claim 1, wherein the housing is a triangular shaped box with the cells on one of the walls that may be positioned to face upwardly, and with another wall being horizontal or vertical.

6. The apparatus of claim 1, wherein the exterior housing may be placed on the ground or may be wall mounted.

7. An apparatus for charging a battery and a battery comprising:
an electrical storage battery;
an array of photovoltaic cells positionable for being exposed to sunlight for activating the cells to generate electricity, and the cells being connected with the battery for charging the battery;
a connection from the cells to charge the battery;
a base unit including the battery;
a plurality of chargeable device charging tips at the base unit, and each tip in turn being connectable with a respective chargeable device for charging the device connected with the tip; each connectable tip being connected with the battery for being supplied with electricity.

8. The apparatus of claim 7, wherein the photovoltaic cells are on a panel that is attached to the base unit.

9. The apparatus of claim 8, wherein the panel of photovoltaic cells is tiltable with respect to the base unit.
